(19) United States
(12) Patent Application Publication
(10) Pub. No.: US 2005/0074530 A1
(43) Pub. Date: Apr. 7, 2005

(54) Integrated spreader

(76) Inventor: Robert Sopher, Villa Park, IL (US)

Correspondence Address: Pauley Petersen & Erickson;Suite 365, 2800 West Higgins Road, Hoffman Estates, IL, 60195, US

(21) Appl. No.: 10/959,229

(22) Filed: Oct. 6, 2004

Related U.S. Application Data
(60) Provisional application No. 60/509,095, filed on Oct. 6, 2003.

(51) Int. Cl. C12C 1/027

(52) U.S. Cl. 426/106

(57) ABSTRACT

A flexible lid sealingly mountable over an opening formed in a container. The lid includes an integrated spreader. With the lid in a flexed position, the integrated spreader is outwardly extendible with respect to a bottom surface of the flexible lid. Also disclosed is a method for transferring a food product from a container onto a surface using the integrated spreader.

### CROSS REFERENCE TO RELATED APPLICATION

This application claims the benefit of U.S. Provisional Application No. 60/509,095, filed on Oct. 6, 2003.

### BACKGROUND OF THE INVENTION

This invention relates generally to a container lid, and, more particularly, to a container lid including an integrated spreader.

### SUMMARY OF THE INVENTION

It is one object of this invention to provide a container lid having an integrated spreader for transferring a product from within a container onto a surface.

It is another object of this invention to provide a flexible container lid having an integrated spreader that extends outwardly with respect to a bottom surface of the container lid, when the container lid is urged towards a flexed position.

The above and other objects of this invention can be attained through a container lid, such as for use with a margarine or butter container, having an integrated spreader. Preferably, the built-in knife like spreader is attached to an inside or bottom surface of the container lid. Preferably, the spreader is attached to one end of the container lid, such as along a tack area or seam. The spreader is preferably but not necessarily constructed of the same material as the container lid, such as a flexible plastic, and is molded, heat sealed or otherwise attached to the bottom surface of the container lid. In one preferred embodiment of this invention, when the container lid is squeezed together, the spreader will protrude or extend outwardly from the container lid and can then be used like a knife to transfer the substance from within the container, such as butter, onto a surface, such as a side of a piece of bread. The spreader can then be used to spread the applied substance about the surface.

The container lid preferably includes a shallow indented crease or similar weakened region across a diameter of the container lid to urge the container lid into a folded or flexed position when squeezed at each end. Preferably, the container lid is gripped at regions on each side and squeezed together, preferably using a thumb and forefinger. When the container lid is squeezed in such a manner, the spreader preferably moves into a forward position relative to the container lid to facilitate extension of the spreader into the container.

The spreader may include serrations along one or more edges. For example, the spreader may include a serrated edge around at least a portion of a perimeter or periphery of the spreader. The spreader may be used to dollop, spread or otherwise transfer the contents of the container from the container to a food item or other location.

The invention further comprehends a method of transferring and/or applying and spreading a product or material onto an object or surface. For example, the container lid having the integrated spreader can be used to transfer a food product onto a surface. At least one force is applied to the flexible lid to bend the flexible lid along a region extending along a diameter of the lid. For example, opposing forces can be applied to the flexible lid at two opposing points on the lid to bend the flexible lid at the region. With the lid in a flexed position, the spreader extends outwardly with respect to the bottom surface of the lid. The spreader is utilized to remove at least a portion of a quantity of the food product from a container and transfer the removed portion of the food product onto the surface. The spreader can be extended into a volume of the container to remove the portion of the food product. After transferring the removed portion of the food product onto the surface, the spreader can be utilized to spread or apply the removed portion along or about the surface.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a top view of a lid, according to one preferred embodiment of this invention;

FIG. 2 is a bottom view of a lid, according to one preferred embodiment of this invention;

FIG. 3 is a perspective side view of a lid, according to one preferred embodiment of this invention;

FIG. 4 is a bottom view of a lid in a relaxed position, according to one preferred embodiment of this invention;

FIG. 5 is a side view of the lid shown in FIG. 4 in a flexed position;

FIG. 6 shows a spreader connected to a bottom surface of a lid in a relaxed position, according to one preferred embodiment of this invention; and

FIG. 7 shows a spreader connected to a bottom surface of a lid in a flexed position, according to one preferred embodiment of this invention.

### DETAILED DESCRIPTION OF THE INVENTION

The present invention provides a flexible lid that is sealingly mountable over an opening formed in a container. The lid includes an integrated spreader having a surface that is generally flush with a bottom surface of the lid, with the lid in a relaxed position. The integrated spreader is outwardly extendible with respect to the bottom surface of the flexible lid, with the lid in a flexed position.

In one preferred embodiment of this invention, a device 10 can be utilized to enclose and transfer a material, such as a spreadable food product, from a container to a surface. For example, the device of this invention can be utilized to transfer a desired quantity of butter or margarine from a container onto a piece of bread, and spread the butter or margarine across or about a surface of the bread piece. Throughout the specification, device 10 of the present invention will be described in reference to transferring and spreading food products, such as butter or margarine. However, it is apparent to those skilled in the art that device 10 may be suitable to transfer and/or spread any desirable spreadable material, such as a paste material or a fluid material.

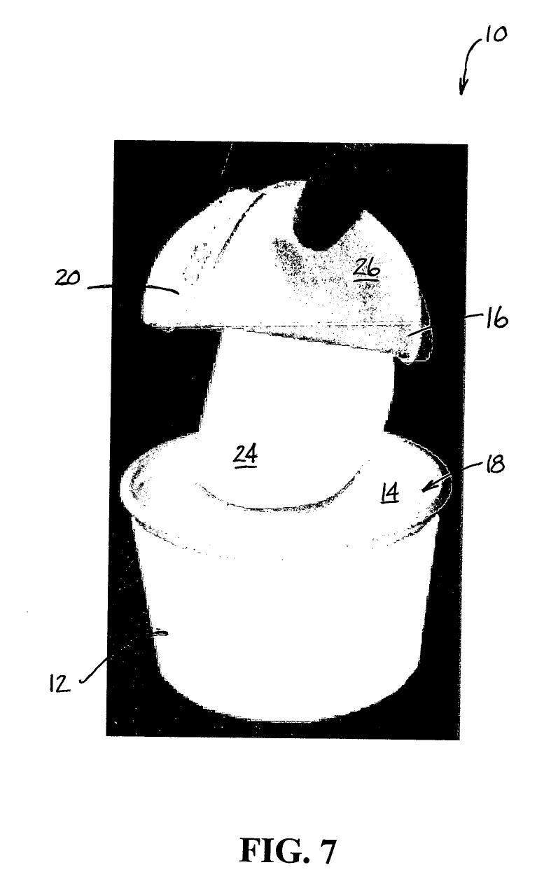

Device 10 includes a container 12, as shown in FIG. 7. Container 12 forms a volume 14 suitable for containing or storing a quantity of a food product. Container 12 is preferably made or a light weight and durable material, such as a flexible plastic material. Other suitable or desirable materials known to those skilled in the art can be used to construct or make container 12. Additionally, container 12 can have any suitable or desirable size and/or shape.

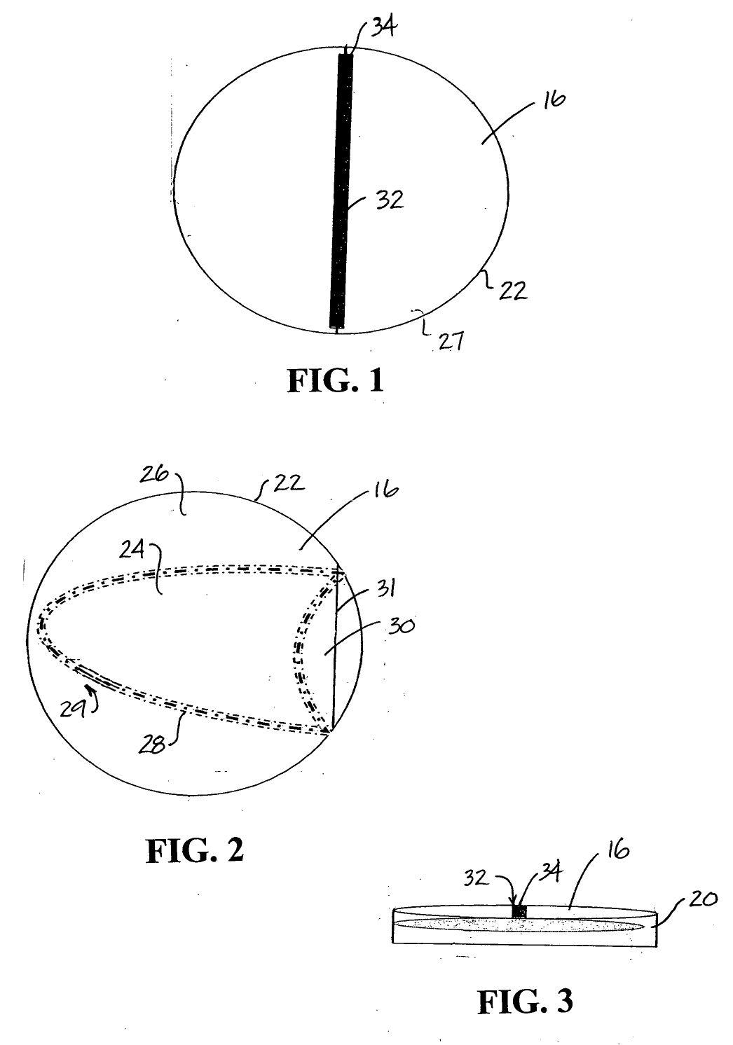

Referring to FIGS. 1-5, a flexible lid 16 is sealingly mountable over an opening 18 formed by container 12. Lid 16 has a suitable size and/or shape for sealingly mounting onto container 12. Lid 16 is preferably but not necessarily made of the same or similar material to the material comprising container 12. In one preferred embodiment of this invention, lid 16 is made of a flexible and/or bendable plastic material. Lid 16 preferably includes a lip 20 extending around an outer periphery 22 of lid 16 to ensure that lid 16 is sealingly mountable onto container 12.

A spreader 24 is connected or attached to an inner or bottom surface 26 of lid 16. In one preferred embodiment of this invention, spreader 24 is integrated with lid 16, such as by molding spreader 24 within lid 16. Alternatively, spreader 24 can be connected or attached to bottom surface 26 using a suitable mechanical connector or spreader 24 can be heat sealed to bottom surface 26. Other suitable methods known to those skilled in the art can be used to attach or connect spreader 24 to lid 16. In one preferred embodiment of this invention, spreader 24 is made of a flexible or bendable material, such as a flexible plastic material. In certain embodiments of this invention, spreader 24 can be made of a rigid material, such as a rigid plastic material, if desired.

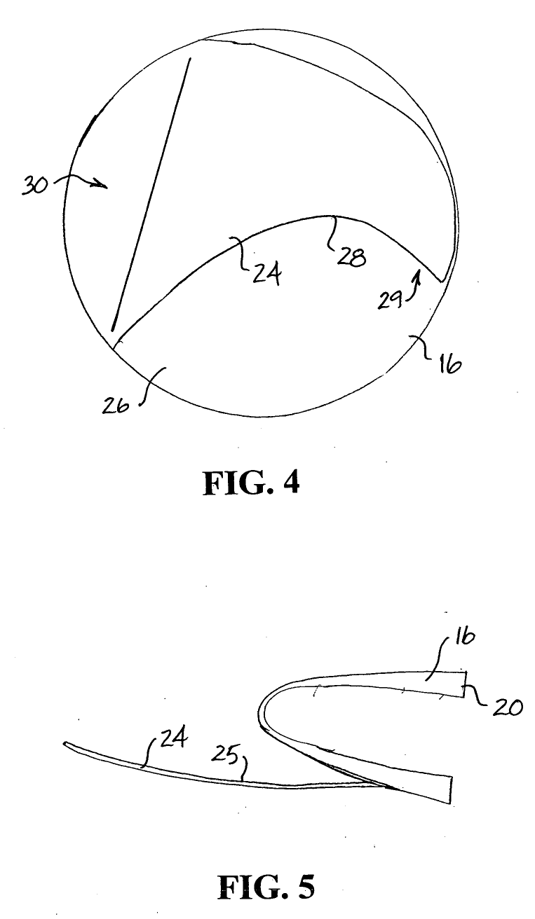

In one preferred embodiment of this invention, at least a portion of a peripheral edge 28 of spreader 24 forms an arcuate shape, as shown in FIGS. 2 and 4. Preferably, spreader 24 includes serrations along at least a portion of peripheral edge 28, such as along an arcuate portion 29.

As shown in FIGS. 2 and 4, spreader 24 is preferably attached or connected to or integrated with lid 16 at a tack area 30 defined on bottom surface 26 of lid 16. Tack area 30 can have any suitable dimensions that allow for a strong attachment or connection between spreader 24 and lid 16. In one preferred embodiment of this invention, tack area 30 includes a seam 31 at which spreader 24 is connected or attached to bottom surface 26.

Lid 16 is movable between a relaxed condition or position, as shown in FIGS. 1-4, and a folded or a flexed condition, as shown in FIG. 5. In the relaxed position, spreader 24 is preferably generally flush with bottom surface 26. For example, a surface 25 of spreader 24 is generally flush with and may contact bottom surface 26 of lid 16. With lid 16 in the flexed position, spreader 24 is outwardly extendable from bottom surface 26 and can be inserted into container volume 14. Preferably, lid 16 includes a region through which lid 16 is bendable to urge lid 16 from the relaxed position to the flexed position. In one preferred embodiment of this invention, the region includes a weakened region 32, as shown in FIG. 1, that biases or urges lid 16 towards the flexed position. A force is applied to lid 16 to urge lid 16 towards the flexed position. Preferably but not necessarily, lid 16 is gripped at opposing regions and squeezed together using a thumb and forefinger. The opposing forces are applied to lid 16 at two opposing points to bend lid 16 at weakened region 32. In one preferred embodiment of this invention, weakened region 32 comprises a crease 34 formed in a top surface 27 of lid 16 and/or a bottom surface 26 of lid 16 that extends along a diameter of lid 16. Preferably, seam 31, as shown in FIG. 2, connecting spreader 24 to lid 16 is generally parallel to crease 24.

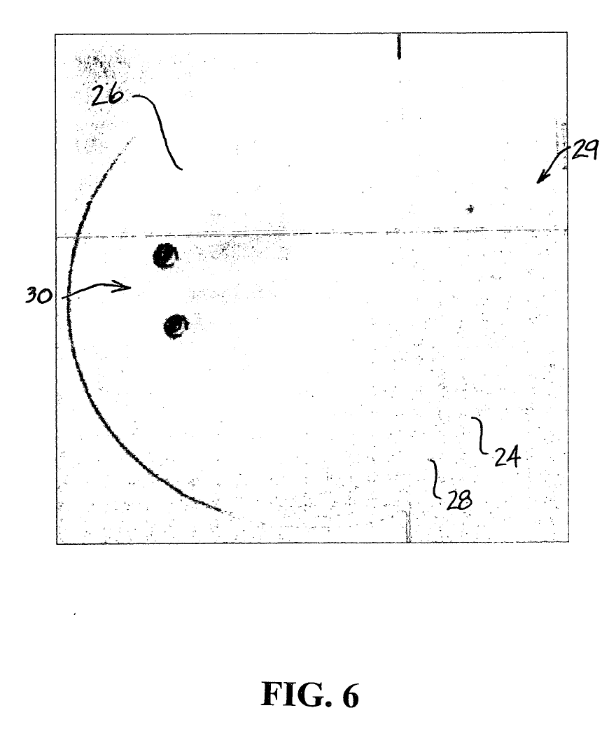

Referring to FIGS. 6 and 7, in one preferred embodiment of this invention, lid 16 including spreader 24 can be used to transfer and/or spread a material, such as a food product, onto a surface. For example, spreader 24 can be used to transfer and/or spread a desired quantity of butter onto a piece of bread. At least one force is applied to flexible lid 16 so that lid 16 bends along a region of lid 16, such as weakened region 32, to a flexed position. Preferably, the region extends along or across a diameter of lid 16. For example, opposing forces are preferably applied to flexible lid 16 at two opposing points on lid 16 to bend flexible lid 16 at weakened region 32.

With lid 16 at the flexed position, spreader 24 is responsively extendable outwardly with respect to bottom surface 26 of lid 16. Spreader 24 can be positioned to extend into volume 14 formed by container 12 to remove a portion of the food product. The user can move the spreader with respect to the food product to transfer a portion of the food product onto spreader 24, such as onto spreader surface 25. Subsequently, the user can transfer the removed portion of the food product from spreader surface 25 onto a surface, such as a piece of bread. If desired, spreader 24 can be moved with respect to the bread surface to distribute or spread the food product along the surface.

Thus, the invention provides a flexible lid that is sealingly mountable over an opening formed in a container. The lid includes an integrated spreader that is generally flush with a bottom surface of the lid with the lid in a relaxed position, and outwardly extendible with respect to the bottom surface of the flexible lid, with the lid in a flexed position, to remove a desired quantity of a product or a material from within the container and transfer, apply and/or spread the removed product or material onto an object or a surface, as desired.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. A flexible lid sealingly mountable over an opening formed in a container, the lid comprising an integrated spreader, in a relaxed position, a surface of the spreader is generally flush with a bottom surface of the lid, with the lid in a flexed position, the integrated spreader is outwardly extendible with respect to the bottom surface.

2. The flexible lid of claim 1 wherein the lid is bendable along a weakened region of the lid.

3. The flexible lid of claim 2 wherein the weakened region extends along a diameter of the lid.

4. The flexible lid of claim 1 wherein in the flexed position, the spreader is insertable into the container.

5. The flexible lid of claim 1 wherein the spreader is made of a flexible material.

6. The flexible lid of claim 1 wherein the spreader is connected to the lid along a seam.

7. A device for enclosing and transferring a food product, the device comprising:
a container containing a quantity of the food product;
a lid sealingly mountable over an opening formed by the container; and
a spreader connected to a bottom surface of the lid, with the lid in a flexed position the spreader is outwardly extendable with respect to the bottom surface.

8. The device of claim 7 further comprising a weakened region formed in a surface of the lid and extending along a diameter of the lid.

9. The device of claim 8 wherein the weakened region comprises a crease formed in a surface of the lid and extending along the diameter of the lid, and the spreader is connected to the lid at a seam generally parallel to the crease.

10. The device of claim 7 wherein the spreader is integrated with the lid.

11. The device of claim 7 wherein the spreader is heat sealed to the lid.

12. The device of claim 7 wherein the spreader further comprises serrations along at least a portion of a peripheral edge of the spreader.

13. The device of claim 7 wherein at least a portion of a peripheral edge of the spreader forms an arcuate shape.

14. The device of claim 7 wherein, in a relaxed position, the spreader is generally flush with the bottom surface.

15. The device of Claim wherein the lid further comprises a lip extending around an outer periphery of the lid to sealingly mount the lid to the container.

16. The device of claim 7 wherein the food product comprises margarine or butter.

17. A method for transferring a food product onto a surface, the method comprising:
applying a force to a flexible lid;
bending the flexible lid along a region of the lid;
responsively extending a spreader connected to the lid outwardly with respect to a bottom surface of the lid;
removing at least a portion of a quantity of the food product from a container using the spreader; and
transferring the removed portion of food product from the spreader onto the surface.

18. The method of claim 17 further comprising the step of spreading the removed portion of the food product along the surface using the spreader.

19. The method of claim 17 wherein the spreader extends into the container to remove the portion of the food product.

20. The method of claim 17 wherein opposing forces are applied to the flexible lid at two opposing points on the lid to bend the flexible lid at the region.
